(19) United States
(12) Patent Application Publication
(10) Pub. No.: US 2018/0096219 A1
(43) Pub. Date: Apr. 5, 2018

(54) NEURAL NETWORK COMBINED IMAGE AND TEXT EVALUATOR AND CLASSIFIER

(71) Applicant: salesforce.com, inc., San Francisco, CA (US)

(72) Inventor: Richard Socher, Menlo Park, CA (US)

(73) Assignee: salesforce.com, inc., San Francisco, CA (US)

(21) Appl. No.: 15/835,261

(22) Filed: Dec. 7, 2017

Related U.S. Application Data
(63) Continuation of application No. 15/421,209, filed on Jan. 31, 2017.
Application No. 15/421,209 is a continuation-in-part of application No. 15/221,541, filed on Jul. 27, 2016.
(60) Provisional application No. 62/236,119, filed on Oct. 1, 2015.

(51) Int. Cl. G06K 9/46; G06N 3/08; G06F 17/27; G06K 9/62

(52) U.S. Cl. CPC G06K 9/4628; G06N 3/08; G06F 17/2715; G06K 9/6296; G06K 9/4671

(57) ABSTRACT

Deep learning is applied to combined image and text analysis of messages that include images and text. A convolutional neural network is trained against the images and a recurrent neural network against the text. A classifier predicts human response to the message, including classifying reactions to the image, to the text, and overall to the message. Visualizations are provided of neural network analytic emphasis on parts of the images and text. Other types of media in messages can also be analyzed by a combination of specialized neural networks.

### RELATED APPLICATIONS

This application is a continuation of U.S. application Ser. No. 15/421,209, entitled “Neural Network Combined Image and Text Evaluator and Classifier”, filed Jan. 31, 2017 (Attorney Docket No. SALE 1166-4/2022USX1), which is a continuation-in-part of U.S. application Ser. No. 15/221,541, entitled “Engagement Estimator”, filed Jul. 27, 2016 (Attorney Docket No. SALE 1166-2/2022US), which claims priority under 35 U.S.C. § 119(e) to U.S. Provisional Application No. 62/236,119, entitled “Engagement Estimator”, filed on Oct. 1, 2015 (Attorney Docket No.: SALE 1166-1/2022PROV), the entire contents of which are hereby incorporated by reference herein.

### INCORPORATIONS

Materials incorporated by reference in this filing include the following: “Dynamic Memory Network”, U.S. patent application Ser. No. 15/170,884, filed Jun. 1, 2016 (Attorney Docket No. SALE 1164-2/2020US) and “Dynamic Memory Network”, U.S. patent application Ser. No. 15/221,532, filed Jul. 27, 2016, (Attorney Docket No. SALE 1164-3/2020USC1).

### FIELD

A neural network architecture applies deep learning to image and text analysis of messages that combine images with text. A convolutional neural network is trained against the images and a recurrent neural network against the text. A classifier predicts human response to the message, including classifying reactions to the image, to the text, and overall to the message. Visualizations are provided of neural network analytic emphasis on parts of the images and text.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

Machine learning is a field of study that gives computers the ability to learn without being explicitly programmed, as defined by Arthur Samuel. As opposed to static programming, trained machine learning algorithms use data to make predictions. Deep learning algorithms are a subset of trained machine learning algorithms that usually operate on raw inputs such as only words, pixels or speech signals.

A machine learning system may be implemented as a set of trained models. Trained models may perform a variety of different tasks on input data. For example, for a text-based input, a trained model may review the input text and identify named entities, such as city names. Another trained model may perform sentiment analysis to determine whether the sentiment of the input text is negative or positive or a gradient in-between.

These tasks train the model machine learning system to understand low level organizational information about words, e.g., how the word is used (identification of a proper name, the sentiment of a collection of words given the sentiment of each). What is needed is teaching and utilizing one or more trained models in higher level analysis, such as predictive activity.

Other aspects and advantages of the technology disclosed can be seen on review of the drawings, the detailed description and the claims, which follow.

### BRIEF DESCRIPTION OF THE FIGURES

The patent or application file contains at least one drawing executed in color. Copies of this patent or patent application publication with color drawing(s) will be provided by the Office upon request and payment of the necessary fee. The color drawings also may be available in PAIR via the Supplemental Content tab.

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 is a block diagram of an engagement estimator learning system in accordance with one embodiment of the present invention.

FIG. 2 is a flow diagram of an engagement estimator learning system in accordance with one embodiment of the present invention.

FIG. 3A and FIG. 3B are example outputs of an engagement estimator learning system in accordance with one embodiment of the present invention.

FIG. 4A and FIG. 4B are example outputs of an engagement estimator learning system in accordance with one embodiment of the present invention.

FIG. 5A and FIG. 5B are example outputs of an engagement estimator learning system in accordance with one embodiment of the present invention.

FIG. 6 is a block diagram of a computer system that may be used with the present invention.

FIG. 7 is an input-to-prediction diagram of an engagement estimator learning system in accordance with one embodiment of the present invention

### DETAILED DESCRIPTION

A system incorporating trained machine learning algorithms may be implemented as a set of one or more trained models. These trained models may perform a variety of different tasks on input data. For example, for a text-based input, a trained model may perform the task of identification and tagging of the parts of speech of sentences within an input data set, and then use the information learned in the performance of that task to identify the places referenced in the input data set by collecting the proper nouns and noun phrases. Another trained model may use the task of identification and tagging of the input data set to perform sentiment analysis to determine whether the input is negative or positive or a gradient in-between.

Machine learning algorithms may be trained by a variety of techniques, such as supervised learning, unsupervised learning, and reinforcement learning. Supervised learning trains a machine with multiple labeled examples. After training, the trained model can receive an unlabeled input and attach one or more labels to it. Each such label has a confidence rating, in one embodiment. The confidence rating reflects how certain the learning system is in the correctness of that label. Machine learning algorithms trained by unsupervised learning receive a set of data and then analyze that data for patterns, clusters, or groupings.

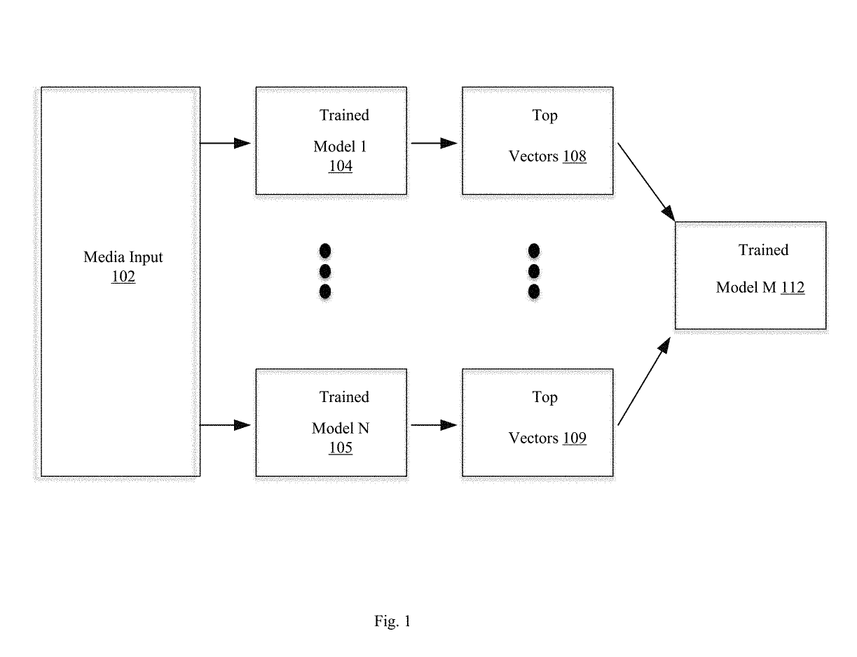

FIG. 1 is a block diagram of an engagement estimator learning system in accordance with one embodiment of the present invention. Input media 102 is applied to one or more trained models 104 and 105. Models are trained on one or more types of media to analyze that data to ascertain engagement of the media. For example, input media 102 may be text input that is applied to trained model 104 that has been trained to determine engagement in text. In another example, input media 102 may be image input that is applied to a trained model 105 that has been trained to determine engagement in images. Input media 102 may include other types of media input, such as video and audio. Input media 102 may also include more than one type of media, such as text and images together, or audio, video and text together.

Trained model 104 is a trained machine learning algorithm that determines vectors of possible outputs from the appropriate media input, along with metadata. In one embodiment, the possible outputs of trained model 104 are a set of engagement vectors and the metadata is an associated confidence. Similarly, trained model 105 is a trained machine learning algorithm that determines vectors of possible outputs from the appropriate media input, along with metadata.

In one embodiment, trained models 104 and 105 are convolutional neural networks (CNNs), such as those described by Socher in “Recursive Deep Learning” the entire contents of which are incorporated by reference earlier. In one implementation described by Socher, a CNN layer extracts low level features from RGB and depth images. These representations are given as inputs to a set of recursive neural networks (RNNs) that map the features. Each of the many RNNs then recursively map the features into a lower dimensional space, and the concatenation of all the resulting vectors form the final feature vector for a softmax classifier which is utilized for the disclosed method to predict engagement for an image. Socher describes, in Section 5.1.2 “Learning Image Representations with Neural Networks”, training a deep convolutional neural network using labeled data to classify 22,000 categories in large image dataset ImageNet, and then using the features at the last layer, before the classifier, as the feature representation. The dimension of the feature vector of the last layer is 4,096. The details are described in the incorporated reference. In another implementation, an off-the-shelf model such as GoogLeNet is pre-trained to form feature vectors for a large image dataset. In “Going deeper with convolutions” Szegedy and others describe their use of a deep convolutional neural network architecture codenamed “Inception” for improving utilization of the computing resources inside the network. One particular incarnation Szegedy used is called GoogLeNet, a 22 layers deep network.

In one embodiment, trained models 104 and 105 are recursive neural networks. Socher describes his recursive neural tensor network (RNTN) which takes as input phrases of any length. Like RNN models, they represent a phrase through word vectors and a parse tree and then compute vectors for higher nodes in the tree using the same tensor-based composition function. The RNTN model computes compositional vector representations for phrases of variable length and syntactic type. These representations are used as features to classify each phrase. Later figures display example tree representation output. When an n-gram is given to the model, it is parsed into a binary tree and each leaf node, corresponding to a word, is represented as a vector. Recursive neural models will then compute parent vectors in a bottom up fashion using different types of compositionality functions. For the disclosed engagement estimator, the parent vectors are given as features to the trained model. In one embodiment, the possible outputs are a set of engagement vectors and the metadata is a set of confidences, one for each associated engagement vector. The top vectors 108, 109 of the possible outputs from trained models 104 and 105 are applied to trained model 112. In one embodiment, trained model 112 is a recursive neural network. In one embodiment, trained model 112 is a convolutional neural network. Trained model 112 processes the top vectors 108, 109 to determine an engagement for the set of media input 102. In one embodiment, trained model 112 is not needed. Engagement confidence scores from trained models 104 and 105, can be to arithmetically combined, such as by calculating their average.

An emerging variation on RNN is the tree-structure long short-term memory (LSTM) network described by Socher et al in “Improved Semantic Representations From Tree-Structured Long Short-Term Memory Networks.” Natural language exhibits syntactic properties that would naturally combine words to phrases. LSTM architecture addresses a difficulty of learning long-distance correlations in a sequence, by introducing a memory cell that is able to preserve state over long periods of time, solving a problem with exploding or vanishing gradients in RNN. The tree-LSTM is a generalization of LSTMs to tree-structured network topologies. As Socher has shown, this variation on RNN, tree-structure LSTM networks can effectively be used in this setting for engagement estimators.

Engagement is a measurement of social response to media content. When the media content is relevant to social media, such as a tweet including a twitpic posted to Twitter™, engagement may be defined or approximated by one or more factors such as:

1. a number of likes, thumbs up, favorites, hearts, or other indicator of enthusiasm towards the content
2. a number of forwards, reshares, re-links, or other indicator of desire to “share” the content with others.

Some combination of likes and forwards above a threshold may indicate engagement with the content, while a combination below another threshold may indicate a lack of engagement (or disengagement or disinterest) with the content. While these are two factors indicating engagement with content, of course other indicators in other combinations are also useful. For example, a number of followers, fans, subscribers or other indicators of the reach or impact of an account distributing the content is relevant to the first level audience for that content and the speed with which it may be disseminated.

The disclosed engagement estimator is useful for determining which words and phrases are more engaging. For example, rhetorical questions such as “you won't believe what happens next!” may earn more attention, and thereby more engagement than a more mundane phrase, “Take a look at this news.”

Some pre-conditioning of engagement data to normalize it based on number of followers, fans, subscribers or other indicators of reach indicate the impact and likely speed of dissemination better than raw numbers. For example, one needs to look further than a simple count of forwards and retweets. To achieve fifty forwards, reshares, or retweets for a post indicates a far more impressive engagement for a user who has one hundred followers than for a celebrity who has thousands of followers. To achieve only fifty forwards, reshares or tweets in the second scenario for the celebrity with thousands of followers would signal a below-average engagement.

A normalizer can be used to prepare a labeled training set for training the recursive neural network and the convolutional neural network. In one case, normalizing on a source entity basis, indications of enthusiasm can include use of an indicator of reach of the source entity. For the example described, a number of retweets 50 can be divided by the number of followers (100) for the message, to normalize the counts and to describe a threshold of engagement. Number of retweets divided by number of followers defines a threshold for engagement. In some implementations, data can be pre-conditioned for a specific area of interest. Some implementations can include training a model jointly and feeding the results into a mechanism that learns the interactions between the text and image.

A model may be trained in accordance with the present invention to use these and/or other indicia of engagement along with the content to create an internal representation of engagement. This training may be the application of a set of tweets plus factors such as the number of likes of each tweet and the number of shares of each tweet. A model trained this way would be able to receive a prospective tweet and use the information from the learning process to predict the engagement of that tweet after it is posted to Twitter™. When the training set is a combination of an image and some text, the engagement predicted by the trained model may be the engagement of each of that image and that text, and/or the engagement of the combination of the two.

In another example, for the content of a song, perhaps the number of downloads of the song, the number of favorites of the song, the number of tweets about the song, and the number of fan pages created for the artist of the song after the song is released may combine into an indication of engagement for the song. Similarly, for the content of online newspaper headlines and the underlying article, the indicia may be some combination of clicks on or click-throughs from the headline, time on page for the article itself, and shares of the article. The same can apply to classified ads, both online and offline. The calculation of engagement is done through identifying one or more items of metadata that is relevant to the content, and training the trained model on the content plus that metadata.

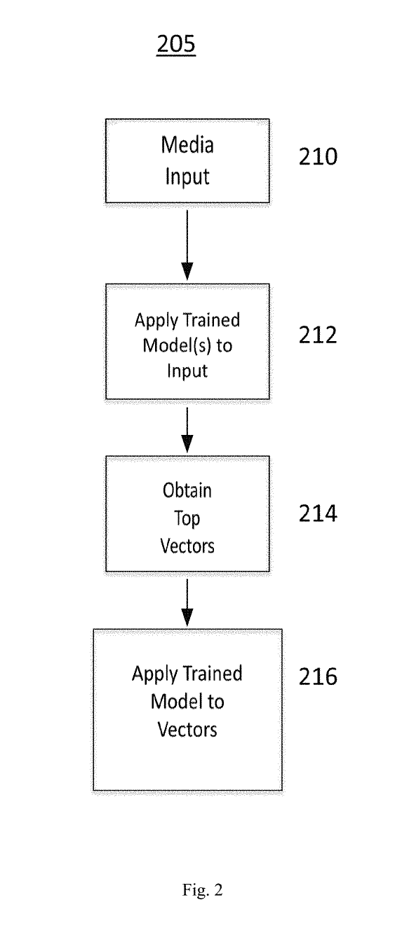

FIG. 2 is a flow diagram of an engagement estimator learning system in accordance with one embodiment of the present invention. Media input 210 is applied to one or more trained model(s) 212 to obtain top vectors 214. In one embodiment, top vectors 108, 109 are used to calculate the overall engagement. In one embodiment, top vectors 108, 109 are applied to one or more trained model(s) 216 to determine the overall engagement.

When the engagement estimator learning system of FIG. 2 is used to predict the Twitter™ social media response of a combination of an image and some text into a prospective tweet, the engagement predicted by the trained model allows the author of the prospective tweet to understand whether the desired response is likely. When the words are not engaging but the image is engaging, the words may be re-written. In some embodiments, the engagement estimator provides suggestions of different ways to communicate the same type of information, but in a more engaging manner, for example, by rearranging word choice to put more positive words in the beginning of the tweet. When the image is not engaging, another image may be chosen. In some embodiments, the engagement estimator provides suggestions of other images that will increase the overall engagement of the tweet. In some embodiments, those suggestions may be correlated to the language used in the text.

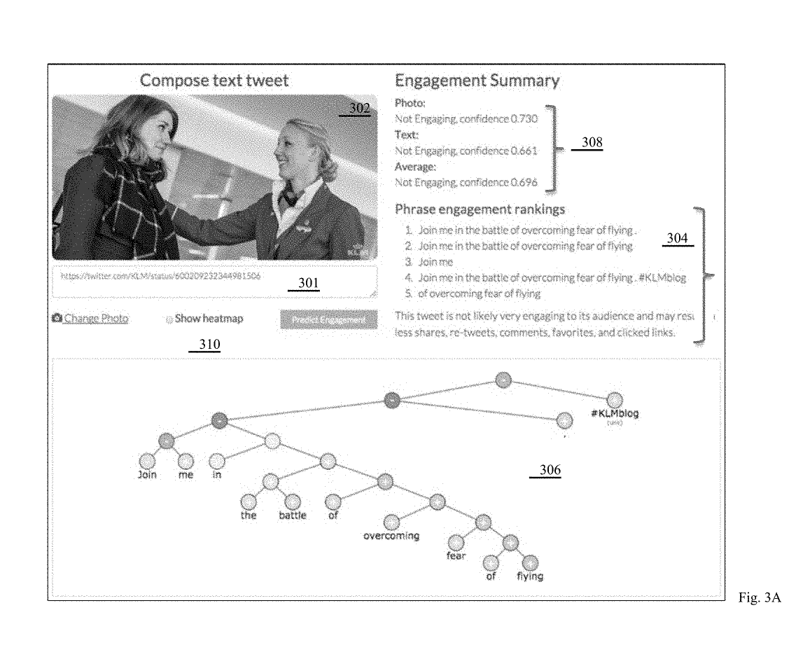

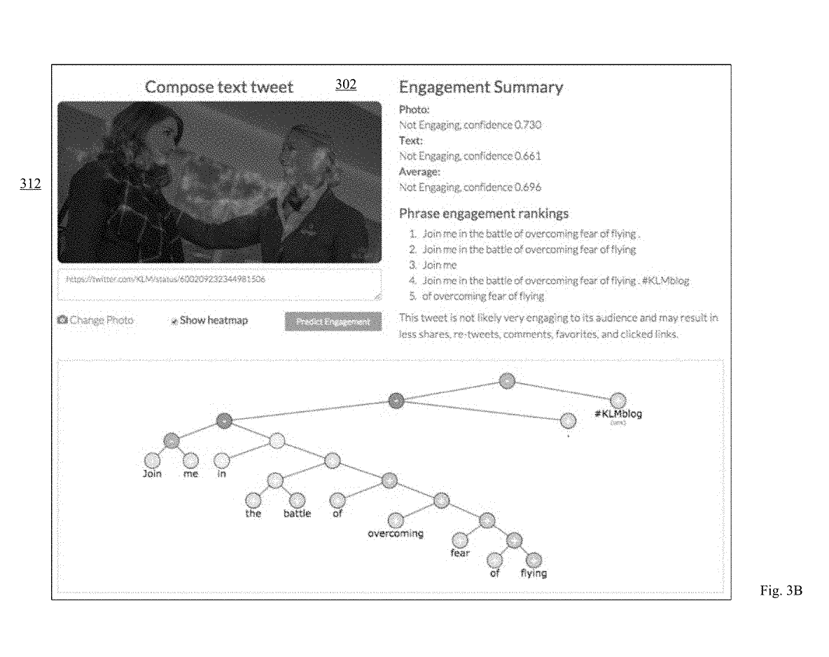

FIG. 3A and FIG. 3B show example outputs of an engagement estimator learning system in accordance with one embodiment of the present invention. In one embodiment, the engagement estimator receives input relevant to a prospective tweet. In one embodiment, media input to the trained models consists of a link to a prospective tweet 301. Text entered in a text box of may also be used, an upload of a prospective tweet, or other manner of applying the media input to the estimated engagement learning system. Tweet 301 consists of an image 302 and a statement 304. The engagement estimator applies image 302 and statement 304 to one or more trained models to obtain an engagement and an associated confidence 308, including a separate engagement score and confidence for the photo, for the text, and for the photo and text together. In one embodiment, the engagement vector for the photo and the engagement for the text from the trained models are applied to another trained model to determine the engagement score for the photo and text together. In one embodiment, this trained model is a recursive neural network. In the present example, there is a high degree of probability that neither the image nor the statement is very engaging. In one embodiment, at least two types of media must be input into the system.

Note the predictive nature of the engagement estimator system. In the past, publishing one or more pieces of media, for example, in social media, had an unknown response. The engagement estimator allows predictive analysis of input media to determine the engagement over two components with different media types in a multimedia message. This engagement may be applied to improving the media, for example, changing the wording of a text or choosing another picture. It may be checking the other advertisements on a web page to ensure that the brand an advertisement is promoting isn't devalued by being placed next to something inappropriate. Engagement may be used for a variety of purposes, for example, it may be correlated to Twitter™ responses—estimating the number of favorites and retweets the input media will receive. A brand may craft a tweet with feedback on engagement of each iteration.

Text engagement map 306 shows which portions of statement 304 contribute to overall engagement. Show heatmap command 310 shows heatmap image 312, to better understand which parts of the photo are more engaging than other parts. In one embodiment, heatmap image 312 shows the amount of contribution each pixel gave to the overall engagement of the photo. In one embodiment, options for changing the statement to a different statement that may be more engaging may be displayed. In one embodiment, suggestions for a more engaging photo may be displayed.

While FIG. 3A and FIG. 3B have been described with respect to a tweet, note that any social media posting may be analyzed this way. For example, a post on a social media site such as Facebook™, an article on a news site, a posting on a blog site, a song or audiobook uploaded to iTunes™ or other music distribution site, a post on a user moderated site such as Reddit™, or even a magazine or newspaper article on an online or offline magazine or newspaper. In some embodiments, trained models may predict responses across social media sites. For example, the engagement of a photo and associated text trained on Twitter™ may be used to approximate the engagement of the same photo and associated text on in a newspaper, online or offline. In some embodiments, models are trained on one type of social media and predict only on that type of social media. In some embodiments, models are trained on more than one type of social media.

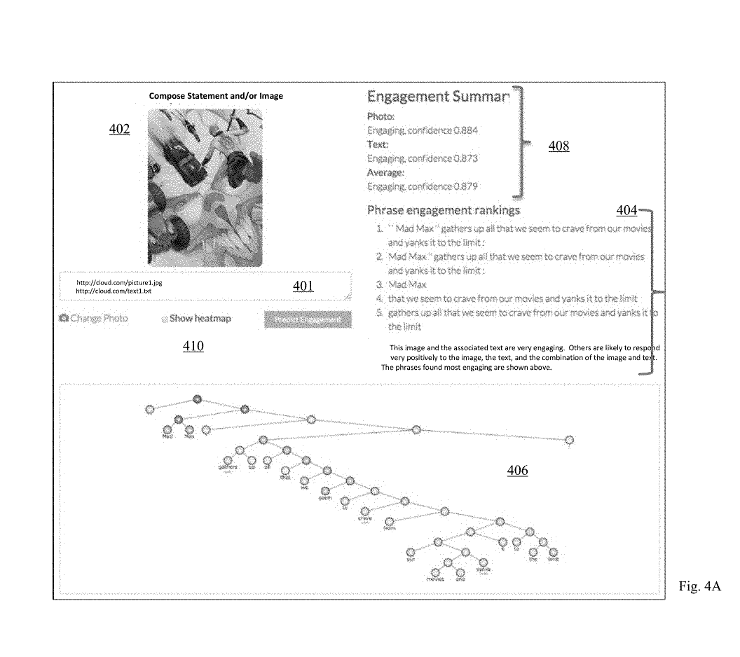

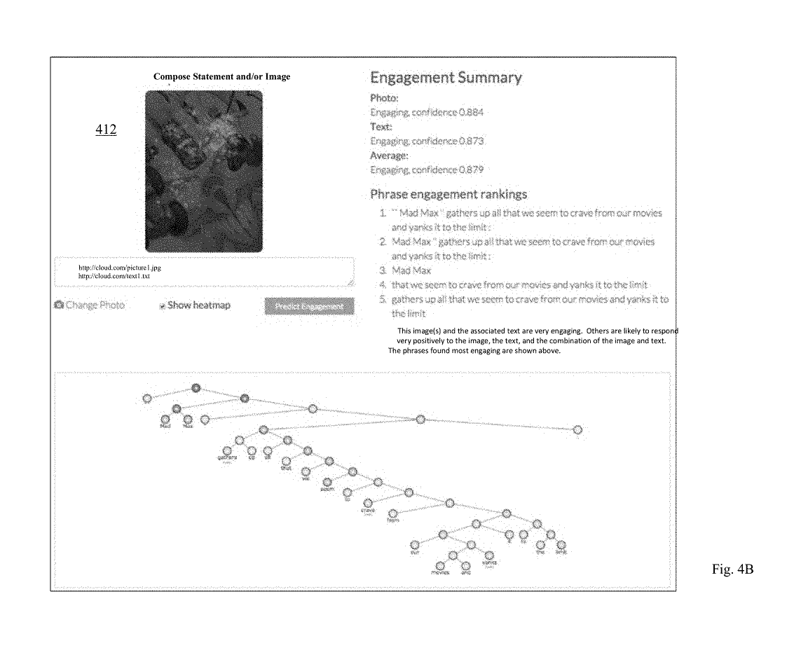

FIG. 4A and FIG. 4B are example outputs of an engagement estimator learning system in accordance with one embodiment of the present invention. In one embodiment, media input to the trained models consists of a link 401 to an image 402 coupled with an audio recording that has been transcribed into a statement 404. Media input may be applied in varying ways, for example, choosing text or an image from a local hard disk drive, via a URL, or dragged and dropped from one location to the engagement estimator system. Other types of input methods may be made, for example, applying a picture and a statement directly, or linking to a web page having the image and audio files. The engagement estimator applies image 402 and statement 404 to one or more trained models to obtain an engagement and a confidence 408, including a separate engagement score and confidence for the photo, for the text, and for the photo and text together. In one embodiment, the engagement score for the photo and text together is calculated by combining the probabilities of engagement given the image and the text. In this example, both the image and the statement are very engaging with a high degree of probability.

Text engagement map 406 shows which portions of statement 304 contribute to overall engagement. Show heatmap command 410 shows heatmap image 412, to better understand which parts of the photo are more engaging than others. In one embodiment, options for changing the statement to a different statement that may be more engaging may be displayed. In one embodiment, suggestions for a more engaging photo may be displayed. This information may be used to post the photo and associated text to a social media site such as Pinterest™, LinkedIn™, or other social media site.

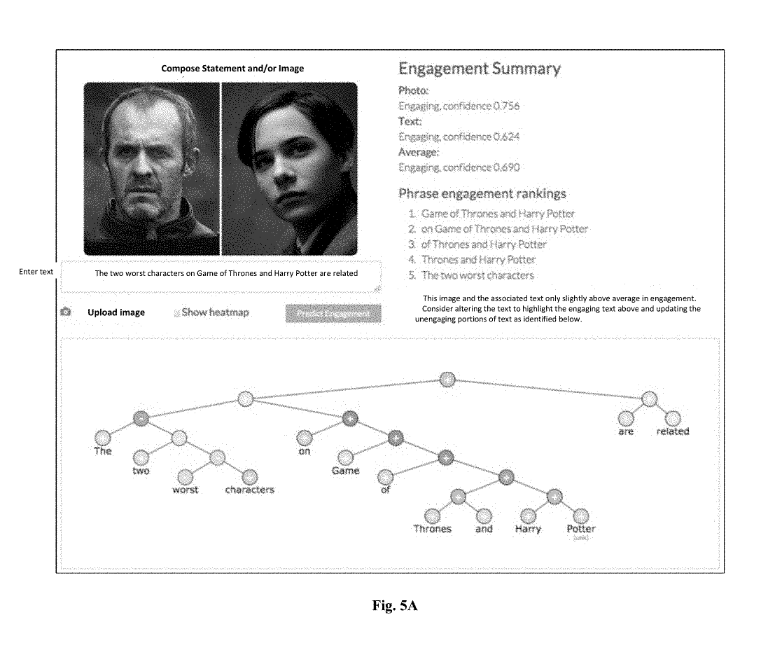

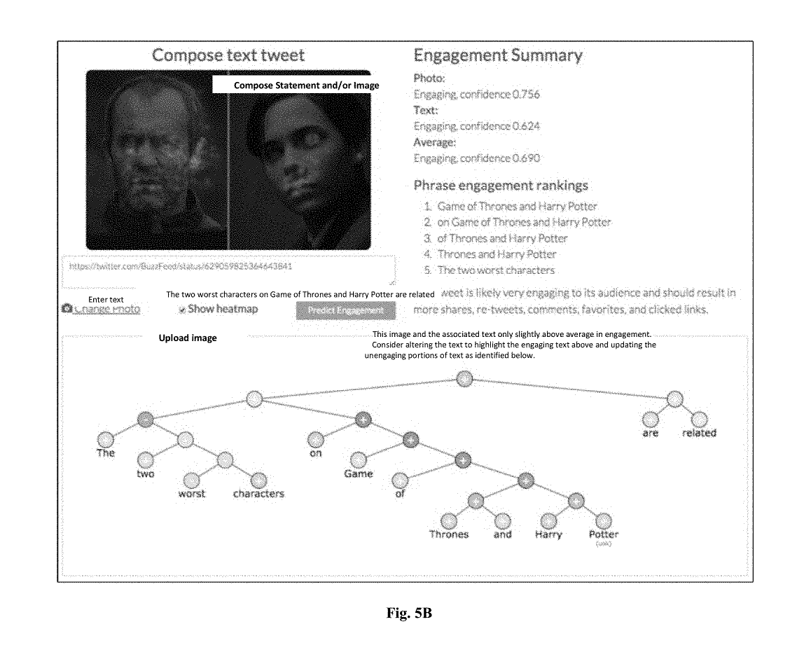

FIG. 5A and FIG. 5B are example outputs of an engagement estimator learning system in accordance with one embodiment of the present invention. Similar to FIG. 4A and FIG. 4B and FIG. 3A and FIG. 3B, one or more images and text are applied to trained models to obtain an engagement estimate for two images and associated text.

Other embodiments may have other combinations of media. For example, a song may be input to the engagement estimator. In some embodiments, the image or images may be uploaded by interaction with an upload button and the text may be entered directly into a text box.

In one implementation a neural network based engagement estimator includes a trained model which, upon receiving a media input, processes the media input to determine a first engagement of the media input. In some implementations, a method of estimating engagement includes applying one or more media inputs to a first trained model; and determining a first engagement for the media input. In some implementations, a method of demonstrating engagement in an image includes applying a convolutional neural network to the image; optimizing on a per pixel basis within the image; and calculating the amount of contribution of each pixel to the overall engagement score.

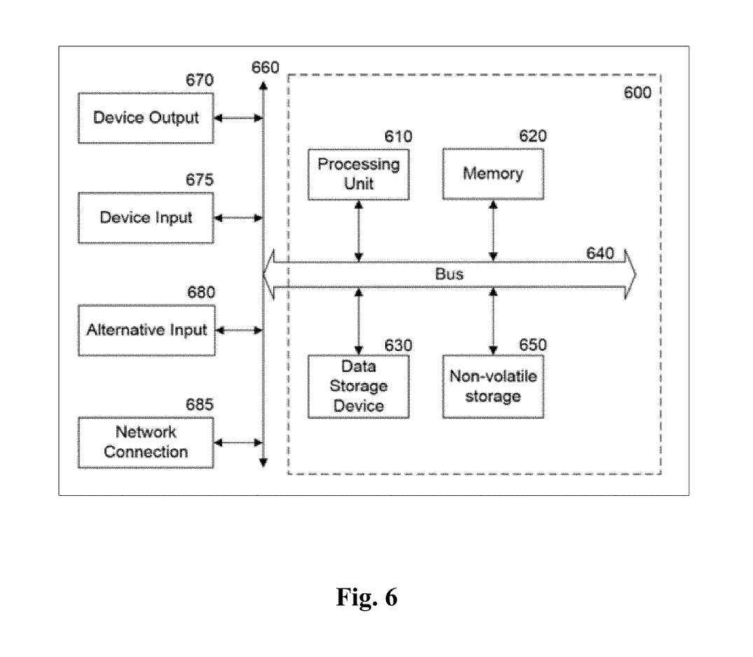

FIG. 6 is a block diagram of a computer system that may be used with the present invention. It will be appreciated by those of ordinary skill in the art that any configuration of the particular machine implemented as the computer system may be used according to the particular implementation. The control logic or software implementing the present invention can be stored on any machine-readable medium locally or remotely accessible to a processor. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

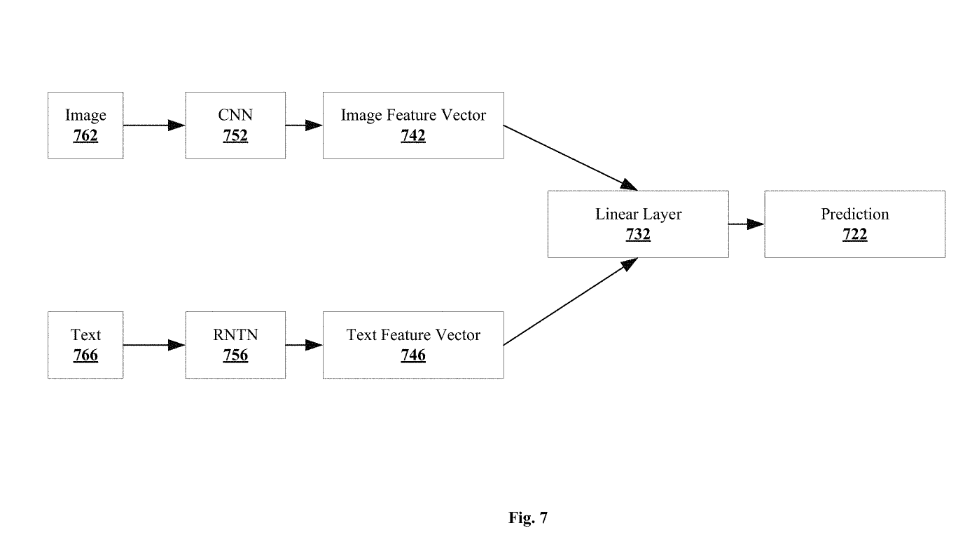

FIG. 7 shows an input-to-prediction diagram of an example engagement estimator learning system in accordance with one embodiment of the present invention. Inputs include image 762 and text 766, such as those shown in earlier figures. For the images, a CNN 752 processes the image data, including the generation of heat maps, to identify areas of the image that are more likely to be engaging, and generates an image feature vector 742 for each image, along with a confidence rating for the image. For text 766, such as tweets or descriptions of images, a recursive neural tensor network (RNTN) 756 generates a text feature vector 746, with a confidence rating for engagement for the text in the tweet or description. Socher describes a linear activation function in detail in “Recursive Deep Learning”, the entire contents of which are incorporated by reference earlier. Linear layer 732 combines the image feature vector 742 and the text feature vector 746, to determine a confidence rating, and prediction 722 for the text and figure and for the combination of the two 308, as shown in FIG. 3A. In one example for the RNTN, a dropout parameter for the tweets can be 25d, to avoid overfitting. In other example implementations the dropout parameter could be 300d.

This technology can be implemented by a trained model which, upon receiving an media input, processes the media input to determine a first engagement of the media input. It also can be implemented by applying one or more media inputs to a first trained model; and determining a first engagement for the media input.

It includes a method of visualizing or demonstrating engagement in an image. This includes applying a convolutional neural network to the image and calculating the amount of contribution of areas within the image to the overall engagement score, then displaying a heat map. The areas can be individual pixels, larger subareas of the image or convolutions of pixel groups. One established procedure for visually representing the amount of contribution of areas within the image in analysis by the convolutional neural network is given by Zeiler et al (2013) Visualizing and Understanding Convolutional Networks. Zeiler's approach was implemented to produce the figures in this application.

In the foregoing specification, the disclosed embodiments have been described with reference to specific exemplary embodiments thereof. It will, however, be evident that various modifications and changes may be made thereto without departing from the broader spirit and scope of the invention as set forth in the appended claims. Similarly, what process steps are listed, steps may not be limited to the order shown or discussed. The specification and drawings are, accordingly, to be regarded in an illustrative rather than a restrictive sense.

### Particular Implementations

In one implementation, a disclosed neural network-based image and text analysis method estimates reactions to media input that includes a text portion and an image portion, the method comprising for the text portion, applying a recursive neural network trained to estimate text-related engagement with the text portion of the media input; and for the image portion, applying a convolutional neural network trained to estimate image-related engagement with the image portion of the media input; and predicting, from output of the trained recursive neural network and the trained convolutional neural network, a composite engagement score that indicates whether the media input will be engaging.

This method and other implementations of the technology disclosed can include one or more of the following features and/or features described in connection with additional methods disclosed. In the interest of conciseness, the combinations of features disclosed in this application are not individually enumerated and are not repeated with each base set of features.

In some implementations, the neural network-based image and text analysis method includes, in the predicting, taking an average of the estimated text-related engagement from the recursive neural network and the estimated image-related engagement from the convolutional neural network. In some implementations, the method further includes, in the predicting, taking vectors produced by the recursive neural network and the convolutional neural network prior to outputting an estimated engagement and applying a neural network that calculates the composite engagement score from the vectors.

For some implementations, the disclosed neural network-based image and text analysis method includes determining contributions of areas within of the image portion of the media input to the estimated image-related engagement of the image portion; and generating a heat map that visually maps the contributions of the areas back onto the image portion of the media input.

The neural network-based image and text analysis method further includes a word and phrase saliency detector that determines contributions of words and phrases within of the text portion of the media input to the estimated text-related engagement of the text portion; and a tree coding generator that visually maps the contributions of the words and phrases back onto the text portion of the media input. The method further includes an image area saliency detector and a word and phrase saliency detector that determine contributions to the composite engagement score, wherein the image area saliency detector applies an occlusion study to determine contributions of areas within of the image portion of the media input to the estimated image-related engagement of the image portion; the word and phrase saliency detector that classifies words and phrases within the text portion of the media input by strength of their contribution to the estimated text-related engagement of the text portion; a heat map generator that visually maps the contributions of the areas back onto the image portion of the media input; and a tree coding generator that visually maps the contributions of the words and phrases back onto the text portion of the media input.

For some disclosed implementations of the neural network-based image and text analysis method, the trained recursive neural network is dynamically configured to have a number of steps based on a number of words in the text portion, and a number of layers based on a depth of branches in a parse tree of the text portion. The disclosed method can further include a normalizer used to prepare a labeled training set for training the recursive neural network and the convolutional neural network, the normalizer normalizing, on a source entity basis, a number of expressions of enthusiasm using an indicator of reach of the source entity. The indicator of reach is a number of followers, fans or subscribers. The number of expressions of enthusiasm is a number of likes, thumbs up, favorites and/or hearts.

Another implementation may include a neural network-based image and text analyzer device, the device including a processor, memory coupled to the processor, and computer instructions loaded into the memory that, when executed, cause the processor to implement a process that can implement any of the methods described above.

Yet another implementation may include a tangible non-transitory computer readable storage medium including computer program instructions that, when executed, cause a computer to implement any of the methods described earlier.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

What is claimed is:

1. A neural network-based image and text analysis method that estimates reactions to media input that includes a text portion and an image portion, the method comprising:
for the text portion, applying a recursive neural network trained to estimate text-related engagement with the text portion of the media input; and
for the image portion, applying a convolutional neural network trained to estimate image-related engagement with the image portion of the media input; and
predicting, from output of the trained recursive neural network and the trained convolutional neural network, a composite engagement score that indicates whether the media input will be engaging.

2. The method of claim 1, further comprising, in the predicting, taking an average of the estimated text-related engagement from the recursive neural network and the estimated image-related engagement from the convolutional neural network.

3. The method of claim 1, further comprising, in the predicting, taking vectors produced by the recursive neural network and the convolutional neural network prior to outputting an estimated engagement and applying a neural network that calculates the composite engagement score from the vectors.

4. The method of claim 1, further comprising:
determining contributions of areas within of the image portion of the media input to the estimated image-related engagement of the image portion; and
generating a heat map that visually maps the contributions of the areas back onto the image portion of the media input.

5. The method of claim 1, further comprising:
a word and phrase saliency detector that determines contributions of words and phrases within of the text portion of the media input to the estimated text-related engagement of the text portion; and
a tree coding generator that visually maps the contributions of the words and phrases back onto the text portion of the media input.

6. The method of claim 1, further comprising:
an image area saliency detector and a word and phrase saliency detector that determine contributions to the composite engagement score;
wherein the image area saliency detector applies an occlusion study to determine contributions of areas within of the image portion of the media input to the estimated image-related engagement of the image portion;
the word and phrase saliency detector that classifies words and phrases within the text portion of the media input by strength of their contribution to the estimated text-related engagement of the text portion;
a heat map generator that visually maps the contributions of the areas back onto the image portion of the media input; and
a tree coding generator that visually maps the contributions of the words and phrases back onto the text portion of the media input.

7. The method of claim 1, wherein:
the trained recursive neural network is dynamically configured to have
a number of steps based on a number of words in the text portion, and
a number of layers based on a depth of branches in a parse tree of the text portion.

8. The method of claim 1, further comprising a normalizer used to prepare a labeled training set for training the recursive neural network and the convolutional neural network, the normalizer normalizing, on a source entity basis, a number of expressions of enthusiasm using an indicator of reach of the source entity.

9. The method of claim 1, wherein the indicator of reach is a number of followers, fans or subscribers.

10. The method of claim 1, wherein the number of expressions of enthusiasm is a number of likes, thumbs up, favorites and/or hearts.

11. A neural network-based image and text analysis system that estimates reactions to media input that includes a text portion and an image portion, the system comprising:
a first level comprising a plurality of trained neural networks running on one or more processors including at least:
for the text portion, a recursive neural network trained to estimate text-related engagement with the text portion of the media input; and
for the image portion, a convolutional neural network trained to estimate image-related engagement with the image portion of the media input;
a second level estimate mixer that accepts input from the trained recursive neural network and the trained convolutional neural network and produces a composite engagement score that predicts whether the media input will be engaging.

12. The engagement estimator system of claim 11, wherein the second level estimate mixer takes an average of the estimated text-related engagement from the recursive neural network and the estimated image-related engagement from the convolutional neural network.

13. The engagement estimator system of claim 11, wherein the second level estimate mixer takes vectors produced by the recursive neural network and the convolutional neural network prior to outputting an estimated engagement and applies a neural network to calculate the composite engagement score from the vectors.

14. The engagement estimator system of claim 11, further comprising:
an image area saliency detector that determines contributions of areas within of the image portion of the media input to the estimated image-related engagement of the image portion; and
a heat map generator that visually maps the contributions of the areas back onto the image portion of the media input.

15. The engagement estimator system of claim 11, further comprising:
a word and phrase saliency detector that determines contributions of words and phrases within of the text portion of the media input to the estimated text-related engagement of the text portion; and
a tree coding generator that visually maps the contributions of the words and phrases back onto the text portion of the media input.

16. The engagement estimator system of claim 11, further comprising:
an image area saliency detector and a word and phrase saliency detector that determine contributions to the composite engagement score;
wherein the image area saliency detector applies an occlusion study to determine contributions of areas within of the image portion of the media input to the estimated image-related engagement of the image portion;
the word and phrase saliency detector that classifies words and phrases within of the text portion of the media input by strength of their contribution to the estimated text-related engagement of the text portion; and
a heat map generator that visually maps the contributions of the areas back onto the image portion of the media input; and
a tree coding generator that visually maps the contributions of the words and phrases back onto the text portion of the media input.

17. The engagement estimator system of claim 11, wherein:
the trained recursive neural network is dynamically configured to have
a number of steps based on a number of words in the text portion and
a number of layers based on a depth of branches in a parse tree of the text portion.

18. The engagement estimator system of claim 11, further comprising a normalizer used to prepare a labeled training set for training the recursive neural network and the convolutional neural network, the normalizer normalizing, on a source entity basis, a number of expressions of enthusiasm using an indicator of reach of the source entity.

19. The engagement estimator system of claim 11, wherein the indicator of reach is a number of followers, fans or subscribers.

20. The engagement estimator system of claim 11, wherein the number of expressions of enthusiasm is a number of likes, thumbs up, favorites and/or hearts.

21. A non-transitory computer readable medium including program instructions that, when executed, implement a neural network-based image and text analysis method that estimates reactions to media input that includes a text portion and an image portion, the method comprising:
for the text portion, applying a recursive neural network trained to estimate text-related engagement with the text portion of the media input; and
for the image portion, applying a convolutional neural network trained to estimate image-related engagement with the image portion of the media input; and
predicting, from output of the trained recursive neural network and the trained convolutional neural network, a composite engagement score that indicates whether the media input will be engaging.

22. The non-transitory computer readable medium of claim 21, further implementing, in the predicting, taking an average of the estimated text-related engagement from the recursive neural network and the estimated image-related engagement from the convolutional neural network.

23. The non-transitory computer readable medium of claim 21, further implementing:
determining contributions of areas within of the image portion of the media input to the estimated image-related engagement of the image portion; and
generating a heat map that visually maps the contributions of the areas back onto the image portion of the media input.

24. The non-transitory computer readable medium of claim 21, further implementing:
a word and phrase saliency detector that determines contributions of words and phrases within of the text portion of the media input to the estimated text-related engagement of the text portion; and
a tree coding generator that visually maps the contributions of the words and phrases back onto the text portion of the media input.

25. The non-transitory computer readable medium of claim 21, further implementing:
an image area saliency detector and a word and phrase saliency detector that determine contributions to the composite engagement score;
wherein the image area saliency detector applies an occlusion study to determine contributions of areas within of the image portion of the media input to the estimated image-related engagement of the image portion;
the word and phrase saliency detector that classifies words and phrases within the text portion of the media input by strength of their contribution to the estimated text-related engagement of the text portion;
a heat map generator that visually maps the contributions of the areas back onto the image portion of the media input; and
a tree coding generator that visually maps the contributions of the words and phrases back onto the text portion of the media input.
